(19) United States
(12) Patent Application Publication
(10) Pub. No.: US 2017/0284536 A1
(43) Pub. Date: Oct. 5, 2017

(54) SHIFT DEVICE

(71) Applicant: ALPS ELECTRIC CO., LTD., Tokyo (JP)

(72) Inventors: Yoshitsugu Wakita, Miyagi-ken (JP); Toshio Ogawa, Miyagi-ken (JP)

(21) Appl. No.: 15/445,223

(22) Filed: Feb. 28, 2017

(30) Foreign Application Priority Data
Mar. 30, 2016 (JP) 2016-068648

(51) Int. Cl. F16H 59/10; G01D 5/16

(52) U.S. Cl. CPC F16H 59/105; G01D 5/16

(57) ABSTRACT

A shift device includes an operating lever, a detection shaft configured to be driven linearly in a first operation direction in response to an operation of the operating lever and be rotated in a second operation direction in response to an operation of the operating lever, a magnet configured to move together with the detection shaft, and two magnetic sensors. The two magnetic sensors detect a movement of the magnet in the two directions to detect a shift position of the operating lever.

### CLAIM OF PRIORITY

This application claims benefit of priority to Japanese Patent Application No. 2016-068648 filed on Mar. 30, 2016, which is hereby incorporated by reference in its entirety.

### BACKGROUND

### 1. Field of the Disclosure

The present disclosure relates to a shift device that detects a shift position of an operating lever in a plurality of operation directions.

### 2. Description of the Related Art

A motor vehicle with an automatic transmission is configured such that a transmission position of the automatic transmission can be designated by operating an operating lever disposed in the vicinity of a center console box.

Shift-by-wire automatic transmissions have recently been developed in which a sensor detects a changed position of an operating lever and an actuator is activated in response to a change signal from the sensor to change a connection state of the transmission.

Such a shift-by-wire automatic transmission includes a shift device that requires no mechanical structure, such as a link mechanism. Such a configuration facilitates miniaturization of the automatic transmission. Furthermore, this configuration allows a shift change to be achieved with a relatively small force and permits flexibility in placement of the shift device in a vehicle interior.

A shift device detecting a shift position with a magnetosensitive element sensitive to a magnetic force of a magnet attached to a shift lever is known in the art (refer to Japanese Unexamined Patent Application Publication No. 2002-144905, for example).

The shift device disclosed in Japanese Unexamined Patent Application Publication No. 2002-144905 includes magnetosensitive elements for individual directions, in which the shift lever is operated, such that a dedicated magnetosensitive element is used in each direction. Disadvantageously, such a configuration results in an increase in number of magnets used, leading to an increase in cost.

### SUMMARY

A shift device includes an operating lever and a detection shaft configured to be driven linearly in a first operation direction in response to a movement of the operating lever in the first operation direction and be rotated in a second operation direction different from the first operation direction in response to a rotation of the operating lever in the second operation direction. A movement of the detection shaft in each of the first and second operation directions causes a shift position of the operating lever in the direction to be detected. The shift device further includes a magnet configured to move together with the detection shaft, a first magnetic sensor configured to detect a change in magnetic flux of the magnet to detect the shift position of the operating lever in the first operation direction, and a second magnetic sensor configured to detect a change in magnetic flux of the magnet to detect the shift position of the operating lever in the second operation direction.

Such a configuration permits the number of magnets used to detect the shift position of the operating lever that can be moved, or operated in the two different directions to be reduced to one. The shift device can be provided with low cost.

### BRIEF DESCRIPTION OF THE DRAWINGS

FIG. 1 is a schematic perspective view of a shift device according to an embodiment of the present invention;

FIG. 2 is an exploded perspective view of the shift device of FIG. 1;

FIG. 3 is a front view of the shift device of FIG. 1;

FIG. 4 is a side view of the shift device of FIG. 1;

FIG. 5 is an enlarged perspective view of a magnet included in the shift device of FIG. 1;

FIG. 6 is a front view of the shift device of FIG. 1 with an operating lever moved in a first operation direction;

FIGS. 7A and 7B are schematic diagrams illustrating detection of a shift position of the operating lever moved in the first operation direction in the shift device of FIG. 1, FIG. 7A illustrating a state before the operating lever is moved, FIG. 7B illustrating a state after the operating lever is moved;

FIG. 8 is a side view of the shift device of FIG. 1 with the operating lever moved in a second operation direction; and

FIGS. 9A and 9B are schematic diagrams illustrating detection of the shift position of the operating lever moved in the second operation direction in the shift device of FIG. 1, FIG. 9A illustrating a state before the operating lever is moved, FIG. 9B illustrating a state after the operating lever is moved.

### DESCRIPTION OF THE EXEMPLARY EMBODIMENTS

A shift device according to embodiments of the present invention will be described with reference to the drawings. Although the shift device which will be described below is included in a shift-by-wire automatic transmission mounted in, for example, a vehicle, an object that includes the shift device according to the present invention is not limited to such an automatic transmission. The shift device according to the present invention can be included in any other object. For example, the shift device can be used for an operating lever of, for example, a home electronic apparatus.

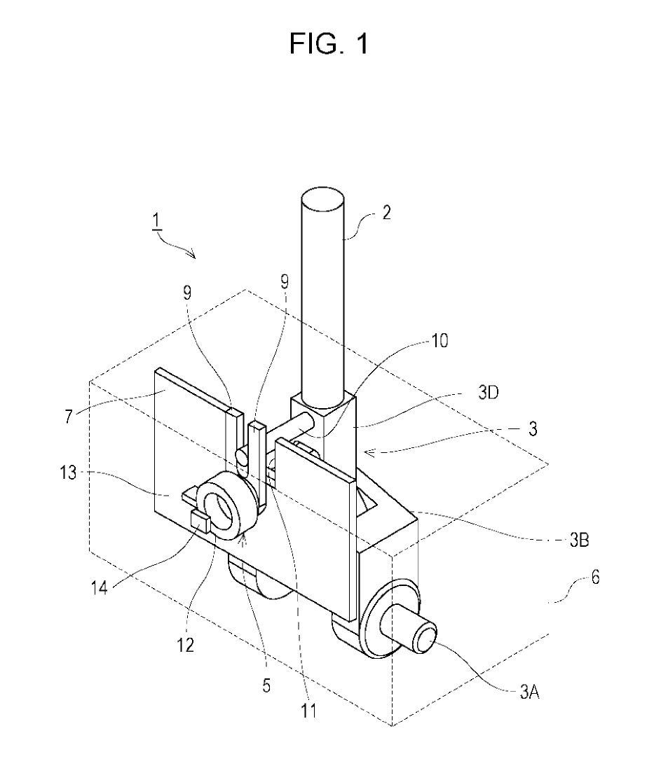

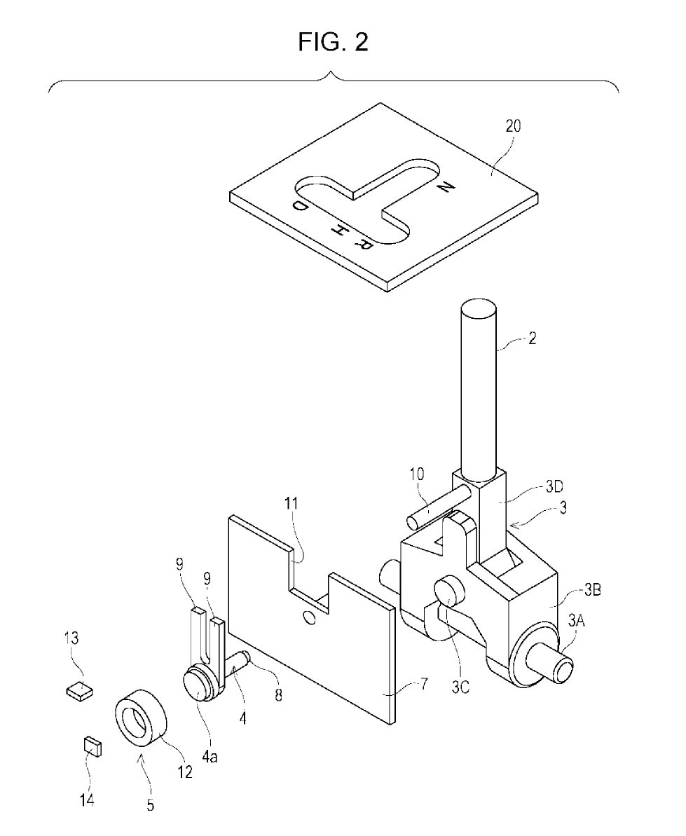

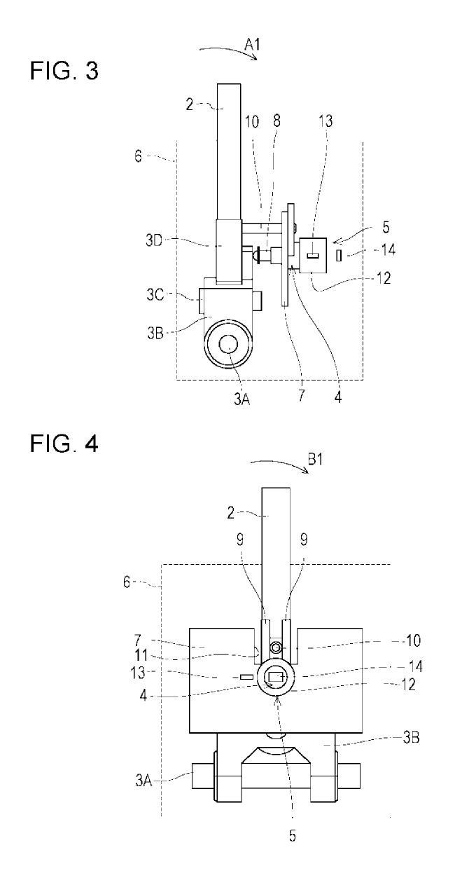

FIG. 1 is a schematic perspective view of a shift device according to an embodiment of the present invention. FIG. 2 is an exploded perspective view of the shift device of FIG. 1. FIG. 3 is a front view of the shift device of FIG. 1. FIG. 4 is a side view of the shift device of FIG. 1.

### Shift Device

The shift device, indicated at 1, includes an operating lever 2, a lever support 3, a detection shaft 4, and a detector 5. The lever support 3 supports the operating lever 2 such that the operating lever 2 is movable in a first operation direction and is rotatable in a second operation direction orthogonal to the first operation direction. The detection shaft 4 is driven linearly in the first operation direction in response to an operation of the operating lever 2 and is rotated in the second operation direction in response to an operation of the operating lever 2. The detector 5 detects a shift position of the operating lever 2 in each operation direction based on a movement of the detection shaft 4.

### Shift Positions

In the shift device 1, the first operation direction means a selection direction of the operating lever 2 and the second operation direction means a shift direction of the operating lever 2. In the selection direction, the operating lever 2 is moved to select a shift position when a shift change is performed with the operating lever 2. In the shift direction, the operating lever 2 is moved to a selected shift position.

As illustrated in FIG. 2, a shift position indicator 20 has capital letters H, N, D, and R that represent shift positions in the selection and shift directions of the operating lever 2. The shift position indicator 20 is disposed in the vicinity of a center console box.

Referring to FIG. 2, the N position, serving as a neutral position, is located in the selection direction of the operating lever 2. The D position, serving as a drive position, and the R position, serving as a reverse position, are located in the shift direction. The H position, serving as a home position of the operating lever 2, is located on the side opposite from the N position in the selection direction.

The H position is an operation reference position of the operating lever 2, that is, an initial position from which the operating lever 2 is moved or operated to another position.

For example, to move the operating lever 2 at the N position to the R position, the operating lever 2 is first moved from the N position to the H position. Then, the operating lever 2 is moved to the R position while an operation state of the operating lever 2 is being maintained.

To move the operating lever 2 at the N position to the D position, the operating lever 2 is first moved from the N position to the H position. Then, the operating lever 2 is moved to the D position while the operation state of the operating lever 2 is being maintained.

The types and number of shift positions in the selection and shift directions of the operating lever 2 in the present invention are not limited to those in the present embodiment. Various modifications of the shift positions may be made.

### Lever Support

The lever support 3 is received in a case 6 attached to, for example, the center console box of the vehicle. The lever support 3 includes a first support shaft 3A and a first support base 3B supported rotatably in the selection direction, serving as the first operation direction, by the first support shaft 3A. The lever support 3 further includes a second support shaft 3C and a second support base 3D supported rotatably in the shift direction, serving as the second operation direction, by the second support shaft 3C. The first support base 3B receives the second support base 3D. The operating lever 2 is fixed at its proximal end to the second support base 3D.

Such a configuration supports the operating lever 2 such that the operating lever 2 is tiltable about the first support shaft 3A in the selection direction and is also tiltable about the second support shaft 3C in the shift direction.

### Detection Shaft

In the case 6, a support plate 7 is disposed on a side on which the H position is located relative to the lever support 3 (in a direction indicated by an arrow A1 (hereinafter, “arrow A1 direction”) in FIG. 3). The support plate 7 is fastened to inner walls of the case 6 such that the surfaces of the support plate 7 are perpendicular to the selection direction.

In the following description, a side or direction toward the H position is defined as a front side or forward, and a side or direction toward the N position is defined as a rear side or backward.

The support plate 7 supports the detection shaft 4 used to detect a shift position of the operating lever 2 in each of the selection direction and the shift direction.

A first actuating shaft 8 for driving the detection shaft 4 linearly in the selection direction extends reciprocatably through the support plate 7. The first actuating shaft 8 includes an elastic member (not illustrated) at its proximal end. The support plate 7 supports the first actuating shaft 8 such that a distal end of the first actuating shaft 8 urged by the elastic member projects from the support plate 7. The distal end of the first actuating shaft 8 is elastically pressed against a side surface of the first support base 3B. The first actuating shaft 8 is attached at its proximal end to the detection shaft 4 such that the first actuating shaft 8 is aligned with the detection shaft 4. A distal end 4a of the detection shaft 4 projects forward.

In such a configuration, when the operating lever 2 at the N position is tilted, or operated in the selection direction (the arrow A1 direction in FIG. 3), the first support base 3B rotates about the first support shaft 3A. The rotation of the first support base 3B causes the first actuating shaft 8 to be pushed forward against an urging force. When the first actuating shaft 8 is pushed, the detection shaft 4 is linearly moved forward. In other words, the detection shaft 4 can be moved linearly in the selection direction by tilting the operating lever 2 in the selection direction.

As described above, when the operating lever 2 is operated such that it is tilted, the detection shaft 4 is moved linearly in the selection direction. Thus, the H position at which the moved operating lever 2 is located can be accurately detected.

When the operating lever 2 is returned from the H position to the N position, the elastic member (not illustrated) causes the detection shaft 4 and the first actuating shaft 8 to automatically return to their initial positions corresponding to the N position.

A second actuating shaft 10 projects from a forward facing side surface of the second support base 3D. A distal end of the second actuating shaft 10 extends through a shaft insertion portion 11, serving as an upper central notch, of the support plate 7 and projects forward from the support plate 7. The distal end of the second actuating shaft 10 is sandwiched and supported between shaft receiving members 9 projecting from an outer circumferential surface of the detection shaft 4.

Such a configuration permits the second support base 3D to rotate about the second support shaft 3C when the operating lever 2 is tilted in the shift direction (toward the D position or the R position). The rotation of the second support base 3D causes the second actuating shaft 10 to rotate together with the second support base 3D. The rotation of the second actuating shaft 10 about the second support shaft 3C causes the shaft receiving members 9 arranged adjacent to the distal end of the second actuating shaft 10 to rotate. The rotation of the shaft receiving members 9 causes the detection shaft 4 to rotate. In other words, tilting the operating lever 2 in the shift direction can rotate the detection shaft 4 in the shift direction. The detection shaft 4, which has been rotated to a position corresponding to the D position or the R position in the shift direction, is rotated to its initial position corresponding to the H position when the operating lever 2 is returned to the H position.

### Detector

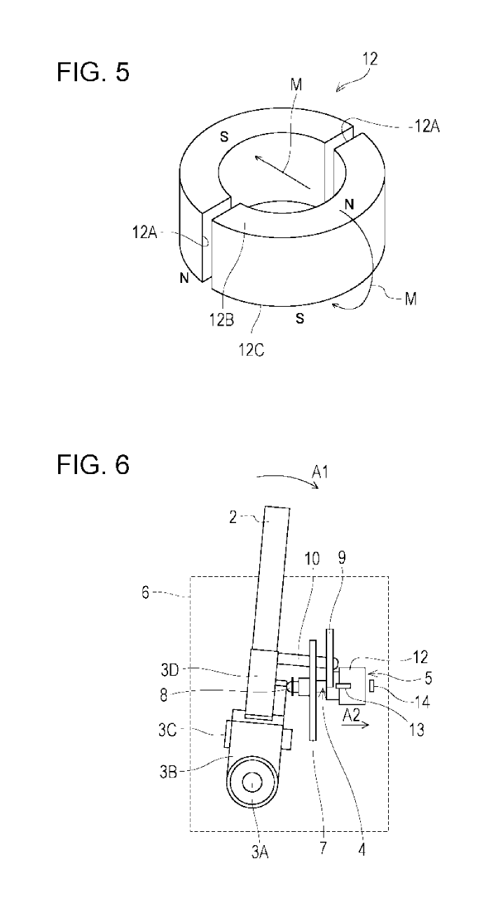

A magnet 12, which is included in the detector 5, is preferably mounted on the distal end 4a of the detection shaft 4. As illustrated in FIG. 5, preferably, the magnet 12 has a ring-like shape and is mounted on the distal end 4a of the detection shaft 4 such that the magnet 12 is coaxial with the detection shaft 4. The magnet 12 is diametrically divided into two pieces. The magnet 12 has two gaps 12A located in diametrical opposed positions.

The magnet 12 may be axially magnetized such that axially opposite surfaces 12B and 12C have different magnetic poles, namely, the N pole and the S pole. The magnet 12 may be diametrically magnetized to different magnetic poles, namely, the N pole and the S pole in plan view.

The magnet 12 with this configuration can generate a magnetic flux M, indicated by an arrow in FIG. 5, in an axial direction of the magnet 12 and further generate a magnetic flux M in a diametrical direction orthogonal to the axial direction.

A first magnetic sensor 13 for detecting a shift position of the detection shaft 4 in the selection direction is disposed at a predetermined distance from the outer circumferential surface of the distal end 4a of the detection shaft 4. The first magnetic sensor 13 may include a giant magnetoresistive element (GMR) 13A. The first magnetic sensor 13 is preferably disposed such that a sensing direction of the first magnetic sensor 13 is parallel to the axis of the detection shaft 4.

In addition, a second magnetic sensor 14 for detecting a shift position of the detection shaft 4 in the shift direction is disposed at a predetermined distance from the distal end 4a of the detection shaft 4. The second magnetic sensor 14 may also include a GMR 14A. The second magnetic sensor 14 is preferably disposed such that a sensing direction of the second magnetic sensor 14 is orthogonal to the axis of the detection shaft 4.

### Detection of Shift Position of Operating Lever

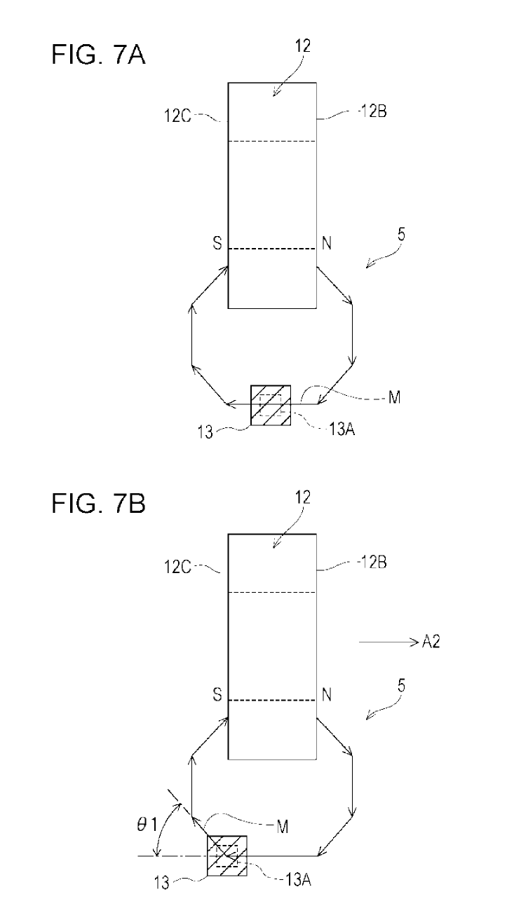

Detection of a shift position of the operating lever 2 will now be described with reference to FIGS. 6, 7A, and 7B.

Detection of a shift position of the operating lever 2 in the selection direction will be described.

Referring to FIG. 3, while the operating lever 2 is located at the N position, the operating lever 2 is perpendicularly supported at the N position by the first support base 3B and the detection shaft 4 is held at the initial position.

As illustrated in FIG. 6, when the operating lever 2 is tilted in the arrow Al direction in FIG. 6 so that the operating lever 2 is moved to the H position, the detection shaft 4 is driven linearly in a direction indicated by an arrow A2 (hereinafter, “arrow A2 direction”) in FIGS. 6 and 7B, that is, in the selection direction (toward the H position), so that the position of the magnet 12 is moved forward.

This movement of the magnet 12 causes the first magnetic sensor 13 to be located adjacent to a rear end of the magnet 12 as illustrated in FIG. 6.

Specifically, the movement of the magnet 12 from a position corresponding to the N position illustrated in FIG. 7A to a position corresponding to the H position illustrated in FIG. 7B causes the first magnetic sensor 13 to detect an angle (θ1) of the magnetic flux M as illustrated in FIG. 7B. A difference in angle of the magnetic flux M caused by the movement of the magnet 12 results in a change in resistance of the GMR 13A. Thus, the movement of the operating lever 2 to the H position is detected.

When the position of the magnet 12 is moved from this state to the position corresponding to the N position in FIG. 7A, a difference in angle of the magnetic flux M causes a change in resistance of the GMR 13A. Consequently, the movement of the operating lever 2 to the N position is detected.

Since the detection shaft 4 can be moved linearly in the selection direction as described above, the angle of the magnetic flux M generated by the magnet 12 can be accurately detected.

Detection of a shift position of the operating lever 2 in the shift direction will now be described.

While the operating lever 2 is located at the H position as illustrated in FIG. 6, the operating lever 2 is supported at the H position by the second support base 3D. At this time, the detection shaft 4 is also held at the initial position.

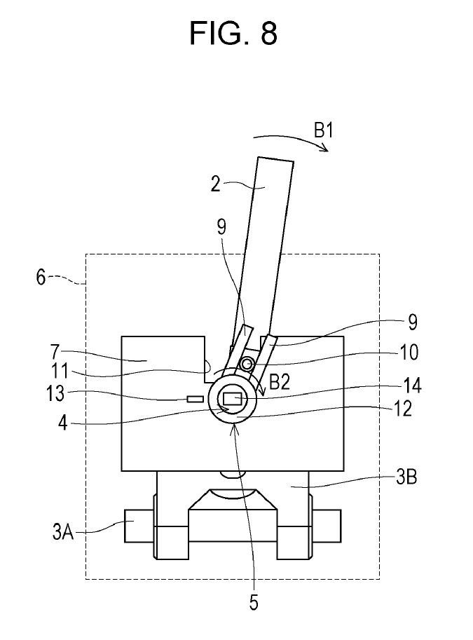

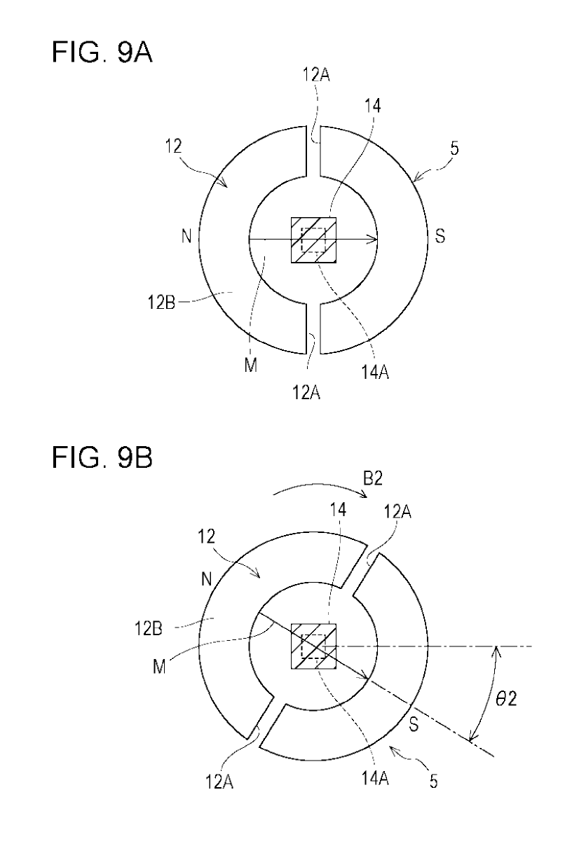

Referring to FIG. 8, when the operating lever 2 is tilted in a direction indicated by an arrow B1 (hereinafter, “arrow B1 direction”) in FIG. 8 such that the operating lever 2 is moved to, for example, the R position, the detection shaft 4 is rotated in a direction indicated by an arrow B2 (hereinafter, “arrow B2 direction”) in FIGS. 8 and 9B and the magnet 12 is also rotated in the same direction.

Specifically, the magnet 12 is rotated from the position corresponding to the H position illustrated in FIG. 9A to the position corresponding to the R position illustrated in FIG. 9B, so that the second magnetic sensor 14 detects an angle (θ2) of the magnetic flux M as illustrated in FIG. 9B. A difference in angle of the magnetic flux M caused by the rotation of the magnet 12 results in a change in resistance of the GMR 14A. Thus, the movement of the operating lever 2 to the R position is detected.

When the magnet 12 is rotated from this state to the position corresponding to the H position in FIG. 9A, a difference in angle of the magnetic flux M causes a change in resistance of the GMR 14A. Consequently, the movement of the operating lever 2 to the H position is detected.

To detect the movement of the operating lever 2 to the D position, the operating lever 2 is moved in a direction opposite to the direction in which the operating lever 2 is moved to the R position. With such an operation, the movement of the operating lever 2 to the D position can be detected in a manner similar to the detection of the movement to the R position.

As described above, the shift device 1 according to this embodiment includes a reduced number of magnets, namely, the single magnet 12 used to detect a shift position of the operating lever 2 that can be moved in the different directions. The shift device can be provided with low cost.

In the shift device 1 according to the embodiment, the magnet 12 is axially magnetized such that the axially opposite surfaces 12B and 12C have different magnetic poles, or the N pole and the S pole. In addition, the magnet 12 is diametrically magnetized to different magnetic poles, or the N pole and the S pole in plan view.

This permits the magnetic fluxes generated by the magnet 12 to stably flow. Thus, a shift position of the operating lever 2 can be reliably detected.

In the shift device 1 according to the embodiment, the first magnetic sensor 13 is disposed such that the sensing direction of the first magnetic sensor 13 is parallel to the axis of rotation of the detection shaft 4, and the second magnetic sensor 14 is disposed such that the sensing direction of the second magnetic sensor 14 is orthogonal to the axis of rotation of the detection shaft 4. The first magnetic sensor 13 detects an angle of the magnetic flux M generated in the axial direction of the magnet 12. The second magnetic sensor 14 detects an angle of the magnetic flux M generated in the diametrical direction of the magnet 12. This configuration enables accurate detection of a shift position of the operating lever 2 moved or operated in the two different directions.

In the shift device 1 according to the embodiment, the magnetic sensors 13 and 14 include the GMRs 13A and 14A, respectively. Since a change in angle of the magnetic flux M passing through each of the magnetic sensors 13 and 14 can be accurately detected, a shift position can be detected with high accuracy.

In the shift device 1 according to the embodiment, the magnet 12 is mounted on the distal end 4a of the detection shaft 4 such that the magnet 12 does not interfere with a movement or operation of the operating lever 2. Thus, a stable movement or operation of the operating lever 2 can be achieved. In addition, flexibility in arrangement space for the magnetic sensors 13 and 14 can be provided.

The above-described embodiment is not intended to limit the present invention. It should be understood by those skilled in the art that various modifications, combinations, sub-combinations, and alternations of the components of the above-described embodiment may be made within the technical scope of the present invention or the equivalents thereof.

In some embodiments, the operating lever is slid in the first operation direction. Since the detection shaft is linearly driven in the first operation direction, a shift position of the operating lever can be accurately detected.

The magnet in the present invention may have any outer shape that allows the magnetic fluxes passing through the magnetic sensors to stably flow in the first and second operation directions. In some embodiments, the magnet has a rectangular outer shape.

The magnet in the present invention does not necessarily have to be mounted on the distal end of the detection shaft. The magnet may be coaxial with the detection shaft and be disposed outside a movement range of the operating lever. In other words, it is only required that the magnet moves together with the detection shaft and the magnetic sensors detect a change in magnetic flux.

The present invention can be applied to various shift devices in which an operating lever can be moved or operated to different positions. The present invention can be applied to a multi-directional input device that inputs various signals in response to operations of an operating lever in multiple directions.

What is claimed is:

1. A shift device comprising:
an operating lever;
a detection shaft configured to be driven linearly in a first operation direction in response to a movement of the operating lever in the first operation direction and be rotated in a second operation direction different from the first operation direction in response to a rotation of the operating lever in the second operation direction, a movement of the detection shaft in each of the first and second operation directions causing a shift position of the operating lever in the direction to be detected;
a magnet that moves together with the detection shaft;
a first magnetic sensor that detects a change in magnetic flux of the magnet to detect the shift position of the operating lever in the first operation direction; and
a second magnetic sensor that detects a change in magnetic flux of the magnet to detect the shift position of the operating lever in the second operation direction.

2. The device according to claim 1,
wherein the magnet has a ring-like shape,
wherein the magnet is axially magnetized in a bipolar manner and is diametrically magnetized in a bipolar manner in plan view, and
wherein the magnet is disposed coaxially with the detection shaft.

3. The device according to claim 2,
wherein the first magnetic sensor is disposed such that a sensing direction of the first magnetic sensor is parallel to an axis of the detection shaft,
wherein the second magnetic sensor is disposed such that a sensing direction of the second magnetic sensor is orthogonal to the axis of the detection shaft,
wherein the first magnetic sensor detects an angle of a magnetic flux generated in an axial direction of the magnet, and
wherein the second magnetic sensor detects an angle of a magnetic flux generated in a diametrical direction of the magnet.

4. The device according to claim 3, wherein the first and second magnetic sensors each include a giant magnetoresistive element.

5. The device according to claim 1, wherein the magnet is disposed outside a movement range of the operating lever.

6. The device according to claim 1, wherein the magnet is mounted on a distal end of the detection shaft.
